(19) United States
(12) Patent Application Publication
(10) Pub. No.: US 2009/0221279 A1
(43) Pub. Date: Sep. 3, 2009

(54) Medthod And Apparatus For Controlling Use Of Mobile Phone While Operating Motor Vehicle

(76) Inventor: Douglas A. Rutledge, Gilbert, AZ (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/270,784

(22) Filed: Nov. 13, 2008

Related U.S. Application Data
(60) Provisional application No. 60/996,345, filed on Nov. 13, 2007.

(51) Int. Cl. H04M 3/00

(52) U.S. Cl. 455/418

(57) ABSTRACT

A method and apparatus for controlling use of mobile communication device while operating a vehicle, wherein the mobile communication device (MS) uses one or more ways to determine its speed while moving in order to alter the default behavior of the device based on a stored safety policy. Using existing technologies such as Global Positioning System (GPS), Assisted GPS (AGPS), Location-Based Services (LBS), Global System for Mobile (GSM), Code Division for Multiple Access (CDMA), or an accelerometer, a MS determines the current or last known state of motion to modify the behavior of the MS based on its speed and a stored safety policy. The human interface of the MS is altered to inform the user of the modification, features and functions can be disabled and enabled, the user is prompted to change their behavior, and automatic functions take place. The logging functions of the MS can be enhanced to record the motion state of the MS while using any feature of the MS.

### CROSS-REFERENCE TO RELATED PATENT APPLICATION

This application claims the benefit under 35 U.S.C. §119(e) of U.S. Provisional Patent Application. No. 60/996,345, filed on Nov. 13, 2007 in the U.S. Patent and Trademark Office, the entire disclosure of which is hereby incorporated by reference.

### FIELD OF THE INVENTION

Embodiments of the present invention relate to telecommunication services and systems, specifically such consumer mobile devices. Specifically, exemplary embodiments of the present invention relate to a method and apparatus for controlling the use of a mobile phone while operation a motor vehicle.

### BACKGROUND OF THE INVENTION

Generally, mobile telecommunication devices are utilized by a large percentage of the population. When these mobile communications devices are used while operating a motor vehicle, public safety is put at risk. Many U.S. states have either passed or are considering legislation to govern the use of mobile communications devices while operating a motor vehicle. The use of these devices for text messaging, e-mail, and talking while driving has been widely publicized as dangerous, yet it still goes on.

Embodiments of the present invention overcome these and other disadvantages in the prior art

### SUMMARY OF THE INVENTION

Exemplary embodiments of the present invention address at least the above problems and/or disadvantages and provide at least the advantages described below.

An object of exemplary embodiments of the present invention is to provide a method and apparatus related to discouraging the non-emergency use of mobile devices while operating a motor vehicle, to enforce safer alternatives such as hands-free headsets while driving, and to maintain a set of safety policies that change the way mobile communications device work based on the speed of the device.

An aspect of exemplary embodiments of the present invention is to provide a mobile communications device that will monitor speed using existing technologies such as Global Positioning System (GPS), Assisted GPS (AGPS), Location-Based Services (LBS), Global System for Mobile (GSM), Code Division for Multiple Access (CDMA), or an accelerometer. Exemplary embodiments of the present invention are compatible with any method to calculate the current speed of the mobile device for each technology is left up to the handset developer. Variations in accuracy should be taken into account when setting values that affect the mobile communications device features or functions.

According to exemplary embodiments, mobile communications devices can always have a “motion state” and/or “state of motion”. The motion state or state of motion is the calculated or stored value of the last known speed. At any given moment the motion state can be updated or examined. The more frequently the motion state is updated, the more accurate and useful the motion state will be. Limitations on battery life and RF (radio frequency) environmental conditions will contribute in part to the frequency the motion state can be updated.

According to an exemplary embodiment, the mobile communications device can have a “safety policy” designed to contain the configuration or rules needed to determine the various actions the mobile communications device should take based on the motion state. This safety policy configuration should have a password-protected configuration menu that allows the mobile communications device to be configured to permit, deny, or alter the use of any feature or function.

According to an exemplary embodiment, the mobile communications device include an “exception list” in a list of phone numbers or contacts stored on the device that can be used to bypass certain safety features. For example, “911” would be a number that can always be dialed when the mobile communications device is in any motion state. If the method is used for parental control, the parent's phone numbers can be in the exception list, allowing calls between the child and parent at any time during any motion state.

According to an exemplary embodiment, the mobile communications device will have one or more values stored on the device to set thresholds. These are values expressed as speed in standard unit values such as miles per hour (MPH), kilometers per hour (KPH), or any other unit of measure that can be met as the speed of a mobile communications device increases or decreases.

According to an exemplary embodiment, the mobile communications device will have a “hold timer”. This is the value expressed in standard time units that indicates the time since the device's speed drops below the threshold value in order to continue blocking the device's features or functions. For example, if a device's features are blocked while driving, this value is used to continue blocking features while slowing and stopping at a traffic signal to prevent its use for this short period where the vehicle may temporarily reduce speed below the threshold.

According to an exemplary embodiment, by monitoring the speed of a mobile communications device, and comparing that speed against variables stored on the device in a safety policy, this invention will discourage the non-emergency use of mobile devices while operating a motor vehicle, enforce safer alternatives such as hands-free headsets while driving, and maintain a set of safety policies that change the way mobile communications devices work based on the speed of the device.

Objects, advantages and salient features of the invention will become apparent to those skilled in the art from the following detailed description, which, taken in conjunction with annexed drawings, discloses exemplary embodiments of the invention.

### BRIEF DESCRIPTION OF THE DRAWINGS

The above and other exemplary features and advantages of certain exemplary embodiments of the present invention will become more apparent from the following description of certain exemplary embodiments thereof when taken in conjunction with the accompanying drawings in which:

FIG. 1 is a diagram illustrating a high-level overview flowchart, according to an exemplary embodiment of the present invention.

FIG. 2 is a diagram illustrating a flowchart of determining and maintaining a “speed state”, according to an exemplary embodiment of the present invention.

FIG. 3 is a diagram illustrating a flowchart for receiving a message (text), according to an exemplary embodiment of the present invention.

FIG. 4 is a diagram illustrating a flowchart for sending a message (text), according to an exemplary embodiment of the present invention.

FIG. 5 is a diagram illustrating a flowchart for handling an incoming call, according to an exemplary embodiment of the present invention.

FIG. 6 is a diagram illustrating a flowchart for a flowchart for handling an outgoing call, according to an exemplary embodiment of the present invention.

Throughout the drawings, like reference numerals will be understood to refer to like elements, features and structures.

### DETAILED DESCRIPTION OF EXEMPLARY EMBODIMENTS

The matters exemplified in this description are provided to assist in a comprehensive understanding of exemplary embodiments of the invention of the present disclosed with reference to the accompanying figures. Accordingly, those of ordinary skill in the art will recognize that various changes and modifications of the exemplary embodiments described herein can be made without departing from the scope and spirit of the claimed invention. Also, descriptions of well-known functions and constructions are omitted for clarity and conciseness.

According to an exemplary embodiment, the present invention provides for a method whereby a mobile communications device (MS) uses one or more ways to determine its speed while moving in order to alter the default behavior of the device based on a stored safety policy. Using existing technologies such as Global Positioning System (GPS), Assisted GPS (AGPS), Location-Based Services (LBS), Global System for Mobile (GSM), Code Division for Multiple Access (CDMA), or an accelerometer, a mobile communications device can determine the current or last known state of motion to modify the behavior of the device based on its speed and a stored safety policy. The human interface of the device can be altered to inform the user of the modification, features and functions can be disabled and enabled, the user can be prompted to change their behavior; and automatic functions can take place. The logging functions of the device can be enhanced to record the motion state of the device while using any feature.

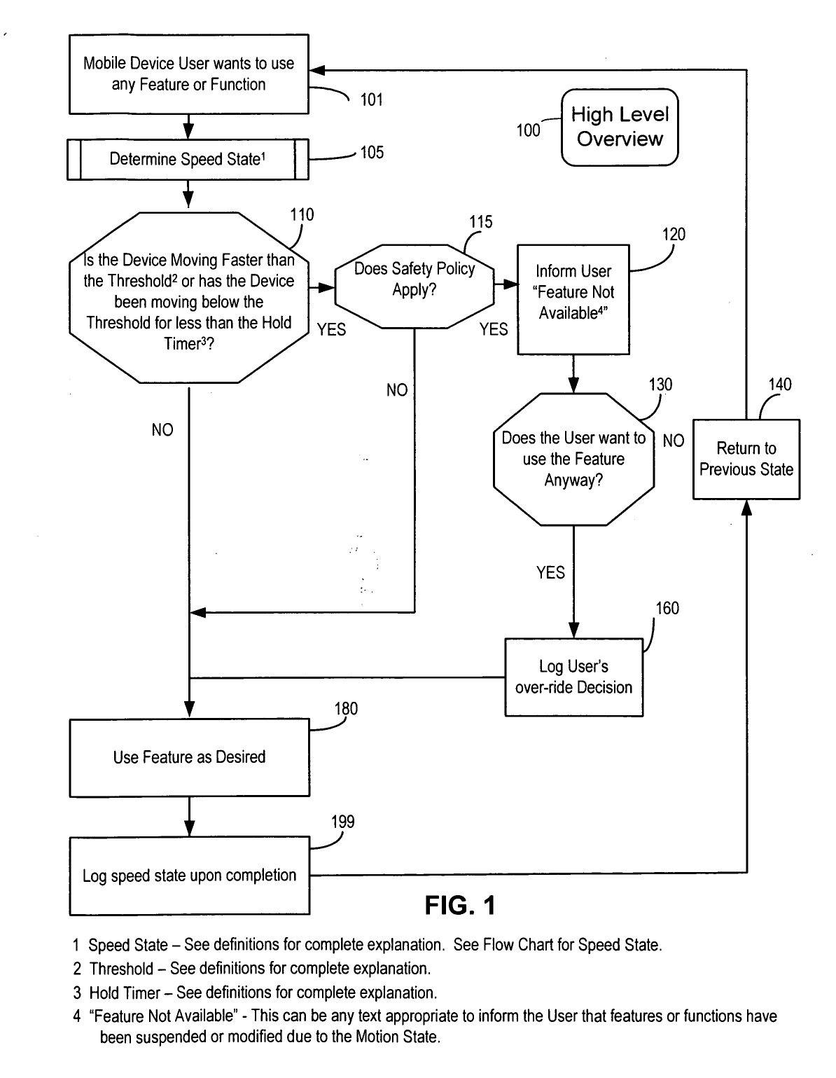

As shown in FIG. 1, a high-level overview, according to an exemplary embodiment of the present invention, when a user wants to use any feature or function of a MS [101] the MS should first check the speed state [105]. If the MS is determined to be moving faster than the threshold or if the device has been slower than the threshold for less than the hold timer [110] then the MS should check the safety policy [115]. If the safety policy is configured to limit the desired MS feature or function then the display of the MS should inform the user that the requested feature or function is not available [120]. It is possible the user may be a passenger and not an operator of the vehicle, so the MS should present the user with an option to use the feature regardless of speed [130]. If the user does not choose to continue, the MS should be returned to its normal standby state [140]. If the user does wish to use the feature or function anyway, then the MS should log the user's decision and permit the user to continue as though they were stationary [160].

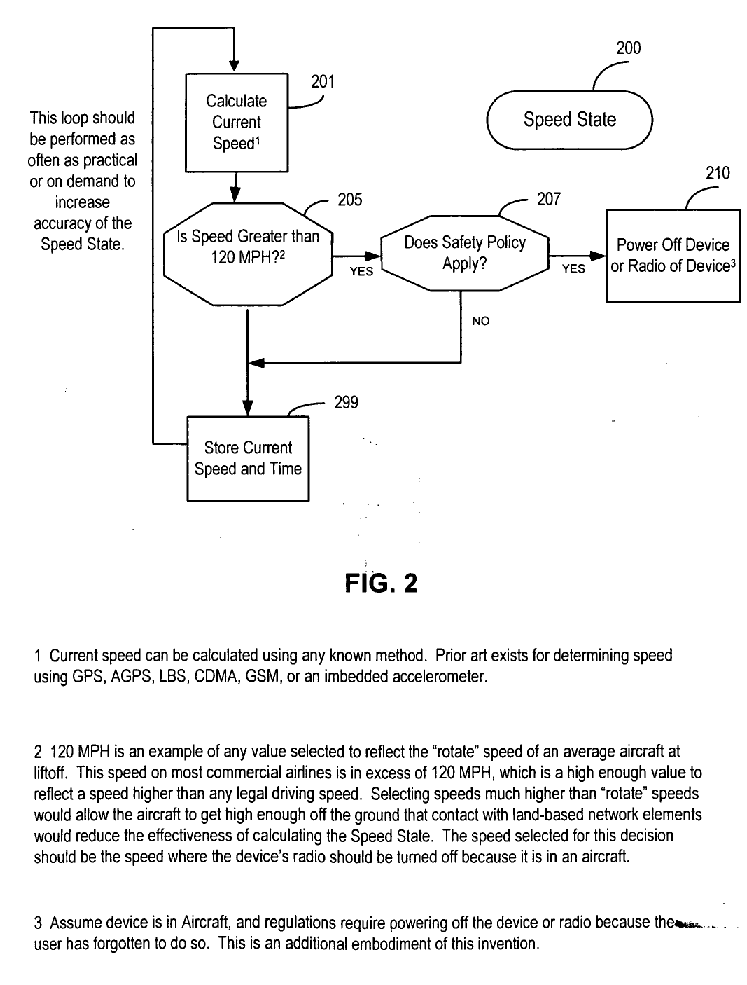

As shown in FIG. 2, the Speed State, according to an exemplary embodiment, the MS can use any method to calculate speed [201] and store it [299]. If the speed is greater than 120 MPH then the MS should power off the radio or the MS [120]. 120 MPH is an example of the value selected to reflect the “rotate” speed of an average aircraft at liftoff, but any value can be selected to meet the purpose of this feature. The rotate speed on most commercial aircraft is in excess of 120 MPH, which is greater than any legal driving speed. Selecting a value too high would allow the aircraft to get high enough off the ground to reduce the effectiveness of communicating with land-based networks. The speed selected for this decision should be the speed where the radio should be powered off in accordance with FAA guidelines. The speed state should be calculated as often as practical to maintain an accurate and current state of speed.

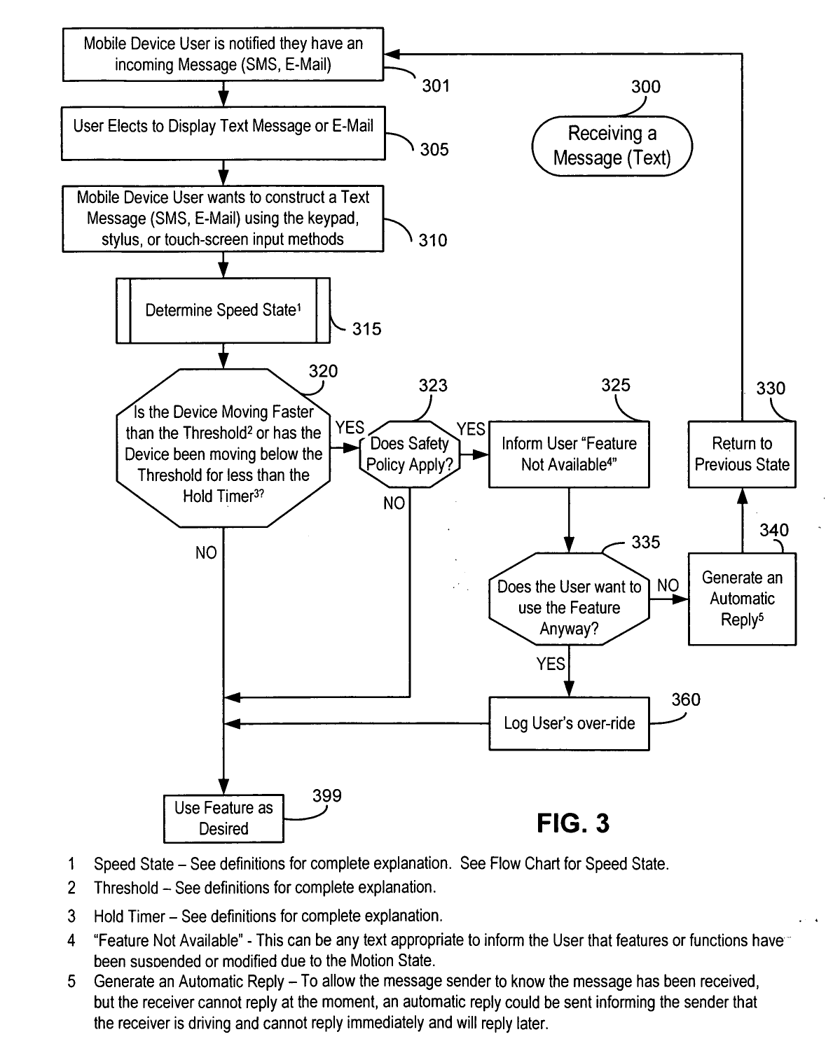

As shown in FIG. 3, for receiving a text message or e-mail, according to an exemplary embodiment of the present invention, when a MS receives a text-based message, the user is notified via SMS [301]. According to exemplary embodiments, SMS can comprise text messages, e-mail, or any other use of text instead of voice. The user may then elect to view the message if the safety policy permits [305]. When the user attempts to reply [310], the MS should check the speed state [320]. If the MS is determined to be moving faster than the threshold or if the device has been slower than the threshold for less than the hold timer [320] then the MS should check the safety policy [323]. If the safety policy is configured to limit the desired MS feature or function then the display of the MS should inform the user that the requested feature or function is not available [325]. It is possible the user may be a passenger and not an operator of the vehicle, so the MS should present the user with an option to use the feature regardless of speed [335]. If the user does not choose to continue, the MS should be returned to its normal standby state [330]. If the user does wish to use the feature or function anyway, then the MS should log the user's decision and permit the user to continue as though they were stationary [360]. It should also be possible (based on the safety policy) for the MS to generate an automatic reply to the sender of the text message informing them that the user is driving and cannot reply until later [340].

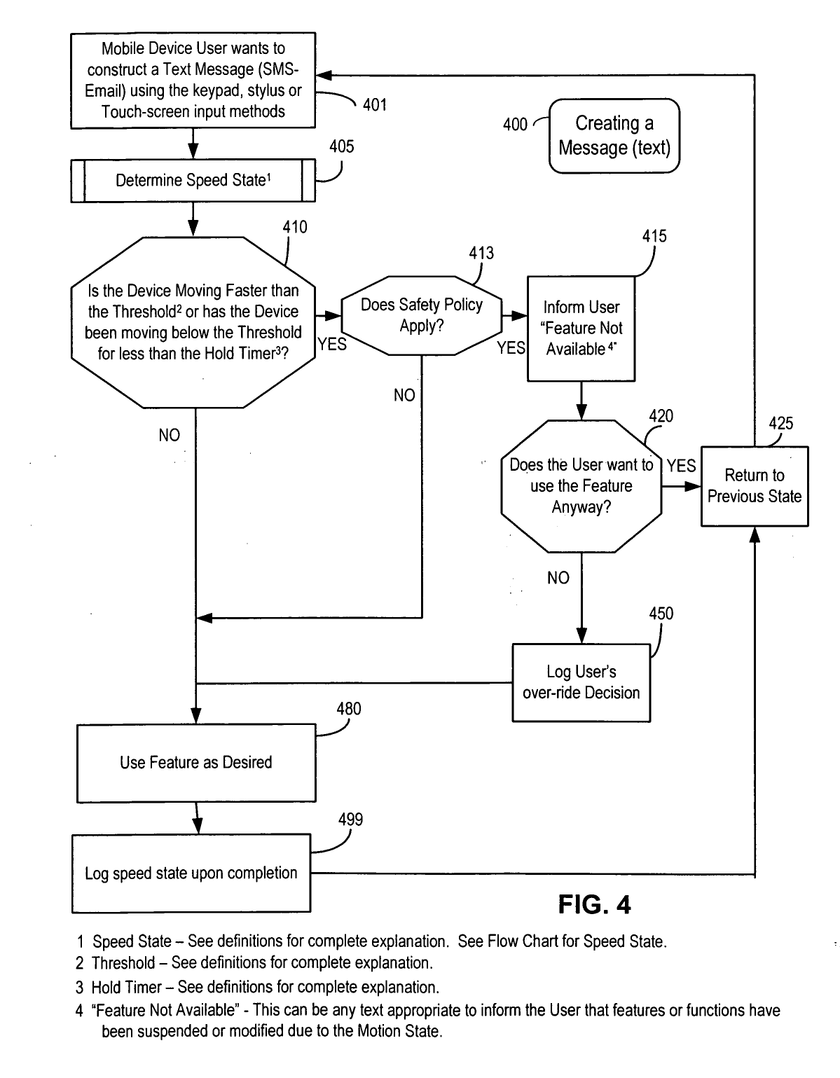

As shown in FIG. 4, for creating a text message or e-mail, according to an exemplary embodiment of the present invention, when the user attempts to construct a text-based message, if the MS is determined to be moving faster than the threshold (see definitions—“Threshold”) or if the device has been slower, the threshold for less than the hold timer [410] then the MS should check the safety policy [413]. If the safety policy is configured to limit the desired MS feature or function then the display of the MS should inform the user that the requested feature or function is not available [415]. It is possible the user may be a passenger and not an operator of the vehicle, so the MS should present the user with an option to use the feature regardless of speed [420]. If the user does not choose to continue, the MS should be returned to its normal standby state [425]. If the user does wish to use the feature or function anyway, then the MS should log the user's decision and permit the user to continue as though they were stationary [450].

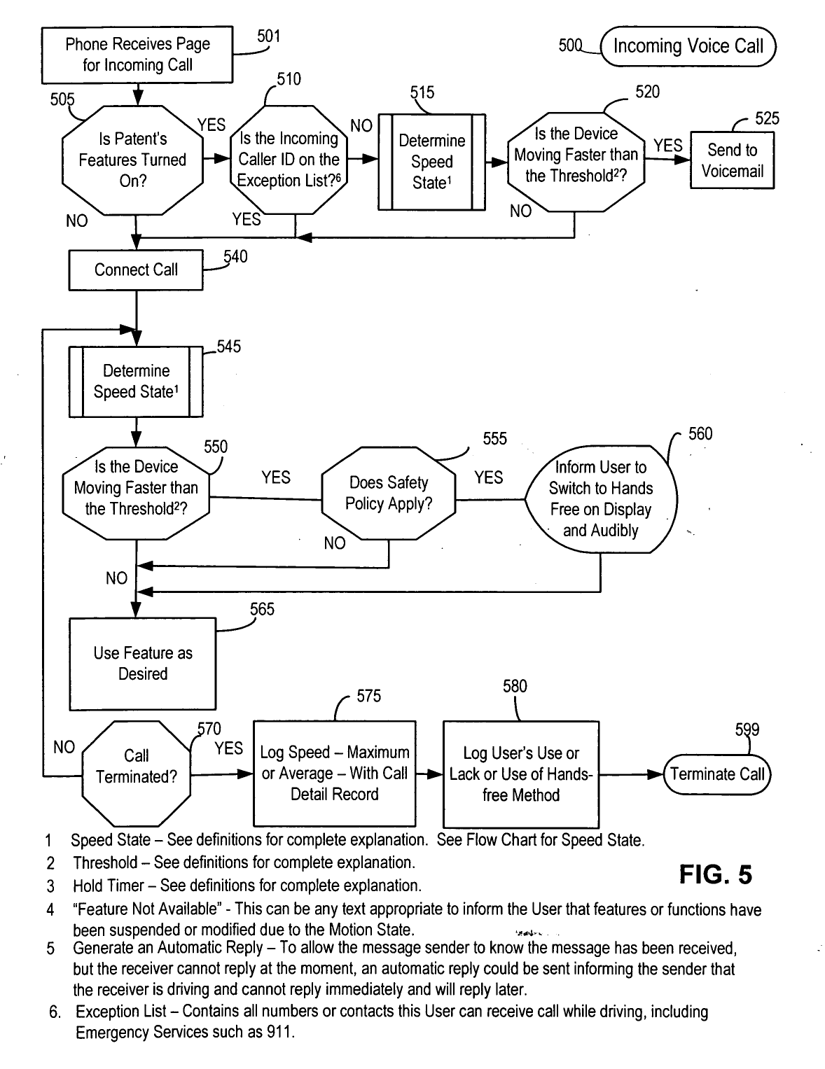

As shown in FIG. 5, for receiving an incoming call, according to an exemplary embodiment of the present invention when a MS receives notification of an incoming call, the MS should check to see if the features previously described are currently enabled [505]. If so, the phone number of the incoming call should be checked against the stored exception list [510], otherwise, connect the call [540]. If the number is not matched to the exception list, then the MS should initiate the routine that checks the speed state [515], otherwise, connect the call [540]. If the device is moving faster than the threshold [520], then send the call to voicemail without ringing the device [525], otherwise, connect the call [540]. After the call is connected [540], the device should initiate the process to determine the speed state during the call [545]. If at any time it is determined that the device is moving faster than the threshold value [550], then check to see if the safety policy applies [555], otherwise continue using the feature normally [565]. If the device is moving faster than the threshold value, then inform the user they should switch to hands-free by either an audible method or on-screen display [560]. This loop of checking the speed state and encouraging the user to switch to hands-free if the threshold speed is exceeded should continue throughout the duration of the call. After the call is terminated, the maximum or average speed should be logged with the other call details [575]. The use of hands-free devices should also be logged [580].

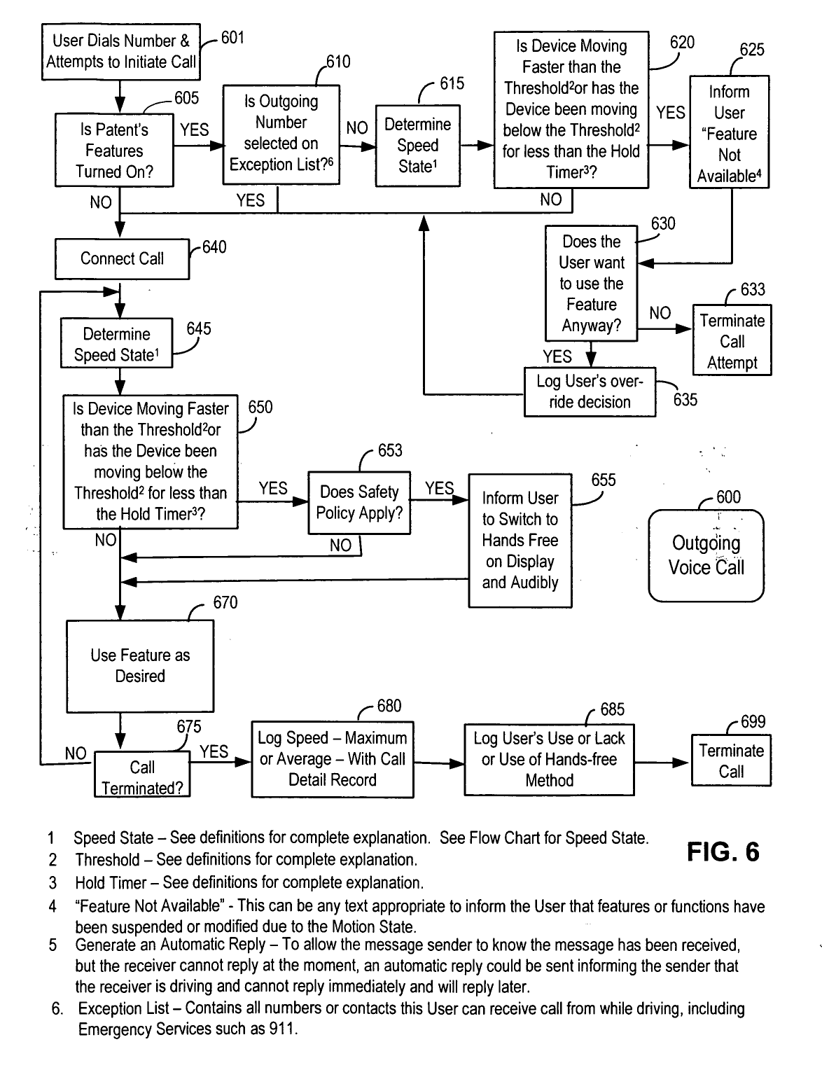

As shown in FIG. 6, for placing an outgoing voice call, according to an exemplary embodiment of the present invention, when the user of a mobile communications device attempts to initiate a voice call, the MS should check to see if these safety features are enabled [605]. If so, check the dialed digits against the exception list [610], otherwise allow the call to connect without further action. If the number is not in the exception list, check the speed state to determine if the speed is greater than the threshold or if the device has been moving at a speed below the threshold for less than the hold timer [620]. If it is, then inform the user that the feature is not available [625]. The user should be presented with a quick, easy option to make the call anyway to account for the times when the user is not the operator of the vehicle, they may be a passenger. If they chose to over-ride the feature [630], log the decision to override and allow the call to connect without further action [635], otherwise just terminate the call attempt [633]. After the call is connected [640], the device should initiate the process to determine the speed state during the call [645]. If at any time it is determined that the device is moving faster than the threshold value [650], then check to see if the safety policy applies [653], otherwise continue using the feature normally [670]. If the device is moving faster than the threshold value, then inform the user they should switch to hands-free by either an audible method or on-screen display [655]. This loop of checking the speed state and encouraging the user to switch to hands-free if the threshold speed is exceeded should continue throughout the duration of the call. After the call is terminated, the maximum or average speed should be logged with the other call details [680]. The use of hands-free devices should also be logged [685].

Definitions

According to exemplary embodiments of the present invention, the following definitions may be helpful:

Motion State

According to exemplary embodiments of the present invention, a MS can have a “motion state” or “state of motion”. The motion state or state of motion is the calculated or stored value of the last known speed. At any given moment the motion state can be updated or examined. The more frequently the motion state is updated, the more accurate and useful the motion state will be. Limitations on battery life and RF conditions will contribute in part to the frequency the motion state is updated.

MS: Mobile Station

Any mobile communications device that uses licensed radio frequencies. See “Cell Phone”.

Cell Phone

Any mobile communications device using radio frequencies in the 700 MHz, 800 MHz, 1900 MHz or other spectrum allocated by the FCC for mobile communications devices. According to exemplary embodiments of the present invention, “cell phone” or “MS” refers to cellular phones, PCS phones, or any other device capable of receiving or transmitting voice or data communications that interfaces with the public telephone system, text messaging, E-Mail, or the Internet.

Accuracy

Variations in accuracy should be taken into account when setting values that affect MS features or functions. There are many methods available to determine the speed of the MS, and all methods differ in accuracy.

Safety Policy

A “safety policy” shall be designed to contain the configuration or rules needed to determine the various actions the MS should take based on the motion state. This safety policy configuration should have a password-protected configuration menu that allows the MS to be configured to permit, deny, or alter the use of any feature or function.

User

Person or persons possessing, using, or owning a MS.

Threshold

This is the value expressed as speed in standard unit values such as miles per hour (MPH), kilometers per hour (KPH), or any other unit of measure that can be met as the speed of a MS increases or decreases.

Hold Timer

This is the value expressed in standard time units that indicates the time since the device's speed drops below the threshold value in order to continue blocking the device's features or functions. For example, if a device's features are blocked while driving, this value is used to continue blocking features while slowing and stopping at a traffic signal to prevent its use for this short period where the vehicle may temporarily reduce speed below the threshold.

SMS: Short Message Service

For purposes of this invention, references to SMS, text messaging (TM), E-mail, and Instant Messaging (IM) are all interchangeable. According to exemplary embodiments, SMS can be for any use of text instead of voice to communicate to or from the MS.

Speed

“Speed” is generally defined to be the rate of motion, or equivalently the rate of change in position, often expressed as distance traveled per unit of time. According to exemplary embodiments of the present invention, speed can be noted as: speed=distance/time.

RF—Radio Frequency

Exception List

The exception list is a list of phone numbers stored on the MS that can be used to bypass certain safety features. For example, “911” would be a number that can always be dialed when the MS is in any motion state. If the method is used for parental control, the parent's phone numbers can be in the exception list, allowing calls between the child and parent at any time during any motion state. The exception list can be a phone number or a reference to numbers stored on the MS.

The above-described exemplary embodiments of an apparatus and method for transmitting/receiving link status may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, et and so on, including a carrier wave transmitting signals specifying the program instructions, data structures, et and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While the present invention has been shown and described with reference to particular illustrative embodiments, it is not to be restricted by the exemplary embodiments but only by the appended claims and their equivalent. It is to be appreciated that those skilled in the art can change or modify the exemplary embodiments without departing from and the scope and spirit of the present invention.

What is claimed is:

1. A method of controlling one or more features of a mobile communication device, the method comprising:
determining a speed at which the mobile communication device is moving;
disabling one or more features of the mobile communication device based on the determined speed; and
enabling one or more features of the mobile communication device based on the determined speed.

2. The method as claimed in claim 1, wherein the speed at which the mobile communication device is moving is determined using one or more of GPS, AGPS and LBS technology.

3. The method as claimed in claim 1, further comprising:
determining whether the mobile communication device is moving in excess of a first speed; and
disabling a text-messaging feature of the mobile communication device if the mobile communication device is traveling in excess of the first speed.

4. A method whereby a mobile communications device determines its speed and stores that value for the purpose of altering the behavior of the device.

5. The method of claim 4, wherein a mobile communications device determines and maintains a motion state or a state of motion,
wherein the motion state or the state of motion is the calculated or stored value of the last known speed which can be updated or examined at any given moment.

6. The method of claim 5, wherein the mobile communications device stores a threshold as a value expressed as speed.

7. The method of claim 5, wherein a hold timer is stored as a value expressed in standard time units that indicates the time since the device's speed drops below the threshold value in order to continue altering the device's features or functions.

8. The method of claim 7, wherein if a device's features are blocked while driving, the hold timer value is used to continue blocking features while stopped at to prevent its use for this short period where the vehicle may temporarily reduce speed below the threshold.

9. The method of claim 5, where an exception list is stored to allow the device to bypass certain safety features.

10. The method of claim 9, wherein, when the device is in any motion state an exception is provided for allowing the device to place calls to emergency numbers.

11. A method of claim 5, wherein a safety policy is stored on the device comprising configuration and/or rules needed to determine the various actions the device should take based on the motion state.

12. The method of claim 11, wherein the safety policy allows the device to be configured to permit, deny, or alter the use of any feature or function.

13. A method of claim 5, wherein a mobile communications device prevents the user from creating text messages or e-mail based on the speed of the device.

14. A method of claim 5, wherein the mobile communications device provides a prompt to use a hands-free option during a call.

15. The method of claim 5, wherein the mobile communication device provides for enforcing or encouraging the use of a wired or wireless headset.

16. A method of claim 5, where an automatic reply is used to respond to an incoming message based on the user's inability to reply while the device is in motion.

17. A method of claim 5, where the device is powered off when a predetermined speed is reached to enforce regulations for turning off the transmitter of any mobile communications device.

18. A method of claim 5, where the logging functions of the device are enhanced to record the speed of the device while using any features of the device.

19. A method of claim 5, where the logging functions of the device includes recording the use of hands-free technologies.

20. A method of claim 5, where one or more feature or function of the device is altered based on speed.
